(19) United States
(12) Patent Application Publication
(10) Pub. No.: US 2020/0342109 A1
(43) Pub. Date: Oct. 29, 2020

(54) BASEBOARD MANAGEMENT CONTROLLER TO CONVEY DATA

(71) Applicant: HEWLETT PACKARD ENTERPRISE DEVELOPMENT LP, Houston, TX (US)

(72) Inventors: Joseph Wright, Tomball, TX (US); Chris Davenport, Houston, TX (US)

(21) Appl. No.: 16/397,538

(22) Filed: Apr. 29, 2019

(51) Int. Cl. G06F 21/57; G06F 3/06; G06F 13/16; G06F 21/74

(52) U.S. Cl. CPC G06F 21/572; G06F 3/0622; G06F 3/0647; G06F 2221/033; G06F 13/1668; G06F 3/0652; G06F 21/74; G06F 3/067

(57) ABSTRACT

Examples disclosed herein relate to using a baseboard management controller (BMC) to convey data between two networks. The BMC has a network interface. Before the BMC connects to a first network, it performs a security assessment including a check on a storage. Then the BMC receives and stores, on the storage, data from the first network. The network interface is then disconnected from the first network and connected to a second network. The data is conveyed to another device using the second network.

### BACKGROUND

Service providers and manufacturers are challenged to deliver quality and value to consumers, for example by providing a secure datacenter environment. This can be accomplished, for example, by using an air gap. An air gap is a network security measure to ensure that a secure computer network is isolated from unsecure networks, such as the Internet or a local area network.

### BRIEF DESCRIPTION OF THE DRAWINGS

The following detailed description references the drawings, wherein:

FIGS. 1 and 2 are block diagrams of computing devices including a baseboard management controller capable to convey data after performing a security assessment, according to various examples;

FIGS. 3-5 are diagrams of a network environment including a computing device that is able to convey data from a first closed network to another network environment, according to various examples;

FIG. 6 is a flowchart of a method for using a baseboard management controller to convey data, according to an example; and

FIG. 7 is a block diagram of a baseboard management controller capable to convey data, according to an example.

Throughout the drawings, identical reference numbers may designate similar, but not necessarily identical, elements. An index number “N” appended to some of the reference numerals may be understood to merely denote plurality and may not necessarily represent the same quantity for each reference numeral having such an index number “N”. Additionally, use herein of a reference numeral without an index number, where such reference numeral is referred to elsewhere with an index number, may be a general reference to the corresponding plural elements, collectively or individually. In another example, an index number of “I,” “M,” etc. can be used in place of index number N.

### DETAILED DESCRIPTION

To protect systems from external intrusions, a common practice is to isolate them on a closed network. While the network is protected, it also isolates valid users from remotely accessing these systems.

Today, physically interfacing with the system has become commonplace. If something occurs to a server in the environment, a technician must find the server, insert a potentially malicious storage (e.g., a universal serial bus (USB) drive, flash memory, etc.), transfer the desired data, then walk the data back to the host system for analysis, transmission, etc. A team of technicians' entire day could be filled with this tedious exercise.

Various examples described herein use a baseboard management controller (BMC) of a computing device to convey data from one network environment to another network environment. The BMC can have a dedicated network interface, which can enable an ability to dynamically traverse network boundaries. Further, because the BMC is part of a separate subsystem of a computing device from a main memory and central processing unit, it can perform a self-assessment on itself, its storage, its network interface, etc. to provide a more secure transaction.

The BMC can enable an air-lock mode to transfer the data. The BMC can perform a security assessment. The security assessment may include a secure erase on a storage used for transfer. The security assessment may also include a confirmation that the BMC is isolated from other network connections. Moreover, the security assessment can include taking a firmware scan of the firmware on the computing device to generate a fingerprint and comparing the fingerprint to a previous firmware scan taken earlier (e.g., a golden firmware fingerprint).

The BMC can then join the isolated network. In the air-lock mode, the BMC can expose a limited application programming interface (API) compared to a normal operation mode. For example, in the air-lock mode, the BMC can limit the availability of webserver functionality, firmware updates, etc.

In this example, the storage can be made available to store payload data. In some examples, the storage is a random access memory (RAM) or flash memory on an application specific integrated circuit (ASIC) that is used to implement the BMC. In other examples, the storage can be coupled to the BMC but isolated from the central processing unit (CPU) of the computing device.

The data can then be conveyed to the storage using the BMC. In one example, an API can be exposed by the BMC to specifically allow for the transfer. In one example, API can be implemented via the network interface. In another example, the API can be implemented via an interface between the BMC and an operating environment of its associated computing device (e.g., via a channel interface (CHIF) driver capable of interfacing between a storage accessible to the BMC and the CPU).

The BMC can then be moved to a second network environment. This network environment includes a target computing device. The BMC can be set up such that the target can retrieve the data from the BMC using an exposed API. In some examples, protections can be built into the API used. In one example, the target computing device can be provided information to connect to the BMC (e.g., a name of the BMC on the network, an IP address, etc.) Further, the target computing device may be able to authenticate with the BMC to receive the storage. In one example, the BMC provides an API with limited available functionality while in the air-lock mode. Accordingly, the target computing device may use a particular API provided by the BMC to retrieve the data from the storage. In another example, the BMC can be configured to look for a particular target computing device and transfer the data using a predetermined method once the target device is present (e.g., the BMC can authenticate with the target device once on the second network environment and then push the data to the target device).

The BMC can then be removed from the second network environment. In one example, the BMC can take another firmware scan and compare with the previous firmware scan's fingerprint to ensure that the BMC and/or other firmware on the computing device was not compromised by connecting to the second network environment. Further, the BMC can perform a secure erase on the storage to ensure that the data conveyed is removed and ensure that the storage cannot have potential malicious information stored thereon.

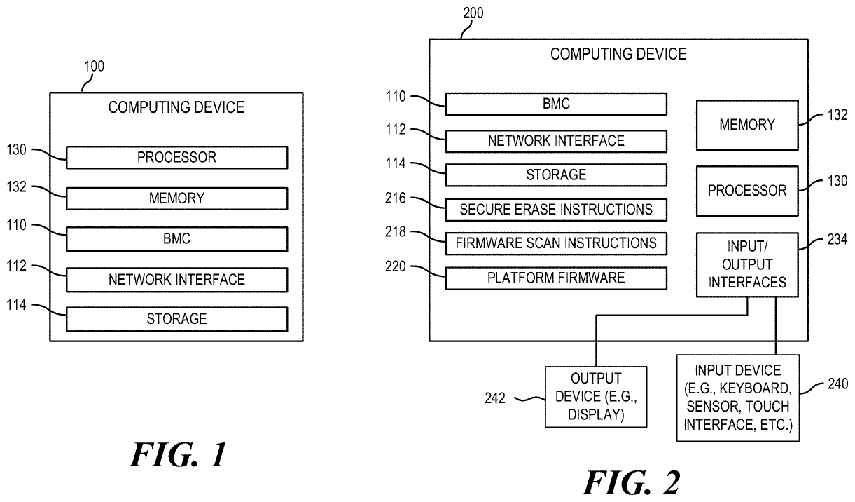

FIGS. 1 and 2 are block diagrams of computing devices including a baseboard management controller capable to convey data after performing a security assessment, according to various examples. Computing devices 100, 200 include components that can be utilized to convey data using a BMC 110. The respective computing devices 100, 200 may be a server such as a blade server, a rack server, an edge server, a tower server, a desktop computer, a workstation, or any other computing device that includes a BMC 110 capable of providing the functionality described herein.

Computing device 100 includes a BMC 110, a network interface 112 coupled to the BMC 110, a storage 114, a processor 130, and memory 132. Computing device 200 further includes secure erase instructions 216, firmware scan instructions 218, platform firmware 220, and input/output interfaces 234. The input/output devices may be connected to, for example an input device 240 and/or an output device 242.

In some examples, the BMC 110 can be used to implement services for the computing device 100, 200. BMC 110 can be implemented using a separate processor from the processor 130 or processing element that is used to execute a high level operating system. BMCs can provide so-called “lights-out” functionality for computing devices. The lights out functionality may allow a user, such as a systems administrator, to perform management operations on the computing device 100, 200 even if an operating system is not installed or not functional on the computing device. Moreover, in one example, the BMC 110 can run on auxiliary power, thus the computing device 100, 200 need not be powered on to an on state where control of the computing device 100, 200 is handed over to an operating system after boot. As examples, the BMC 110 may provide so-called “out-of-band” services, such as remote console access, remote reboot and power management functionality, monitoring health of the system, access to system logs, and the like. As used herein, a BMC 110 has management capabilities for sub-systems of a computing device 100, 200, and is separate from a processor or processing element that executes a main operating system of a computing device (e.g., a server or set of servers).

As noted, in some instances, the BMC 110 may enable lights-out management of the computing device 100, 200, which provides remote management access (e.g., system console access) regardless of whether the computing device 100, 200 is powered on, whether a primary network subsystem hardware is functioning, or whether an OS is operating or even installed. The BMC 110 may comprise an interface, such as a network interface 112, and/or serial interface that an administrator can use to remotely communicate with the BMC 110. As used herein, an “out-of-band” service is a service provided by the BMC 110 via a dedicated management channel (e.g., the network interface or serial interface) and is available whether the computing device 100, 200 is in powered on state. In some examples, the network interface 112 can be implemented using an application specific integrated circuit (ASIC). An example of a network interface 112 can include an Ethernet interface. This may include an Ethernet port.

In some examples, a BMC 110 may be included as part of an enclosure. In other examples, a BMC 110 may be included in one or more of the servers (e.g., as part of the management subsystem of the server) or connected via an interface (e.g., a peripheral interface). In some examples, sensors associated with the BMC 110 can measure internal physical variables such as humidity, temperature, power supply voltage, communications parameters, fan speeds, operating system functions, or the like. The BMC 110 may also be able to reboot or power cycle the device. As noted, the BMC 110 allows for remote management of the device, as such, notifications can be made to a centralized station using the BMC 110 and passwords or other user entry can be implemented via the BMC 110.

Storage 114 can be coupled to the BMC 110 or be included within the BMC 110. In some examples, the storage 114 can include a flash memory such as a NAND device. In other examples, storage 114 can include a random access memory. The storage 114 may be volatile or non-volatile depending on implementation. The BMC 110 can access the storage 114 and may be able to provide the storage 114, via an API, for read and/or write access via the network interface 112.

Firmware engines can be implemented using instructions executable by a processor and/or logic. In some examples, one or more firmware engines can be implemented as platform firmware 220. Platform firmware 220 may include an interface such as a basic input/output system (BIOS) or unified extensible firmware interface (UEFI) to allow it to be interfaced with. The platform firmware 220 can be located at an address space where the processor 130 (e.g., CPU) for the computing device 100, 200 boots.

In some examples, the platform firmware 220 may be responsible for a power on self-test for the computing device 100, 200. In other examples, the platform firmware can be responsible for the boot process and what, if any, operating system to load onto the computing device 100, 200. Further, the execution of platform firmware may be able to initialize various components of the computing device 100, 200 such as peripherals, memory devices 132, memory controller settings, storage controller settings, bus speeds, video card information, etc. In some examples, execution of platform firmware can also be able to perform various low level functionality while the computing device 100, 200 executes. Moreover, in some examples, routines as part of execution of platform firmware 220 may be able to communicate with a higher level operating system executing on a CPU, for example via an advanced configuration and power interface (ACPI).

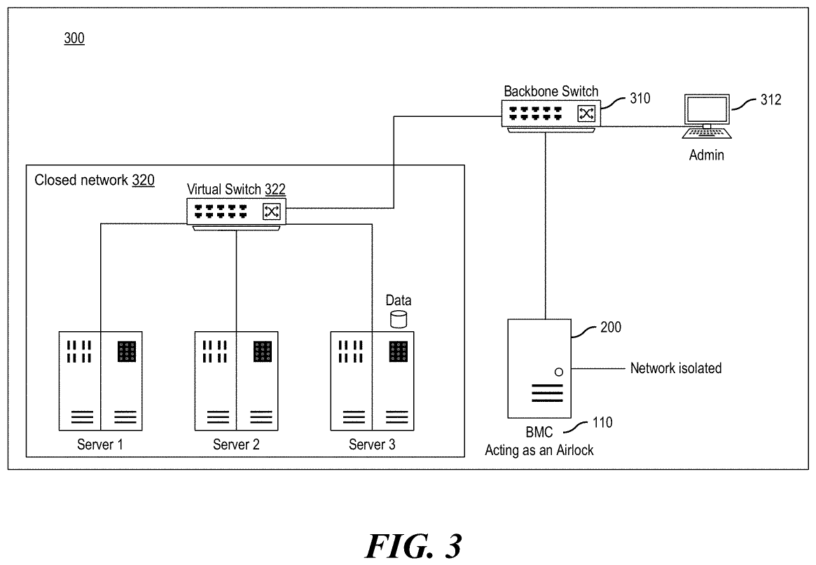

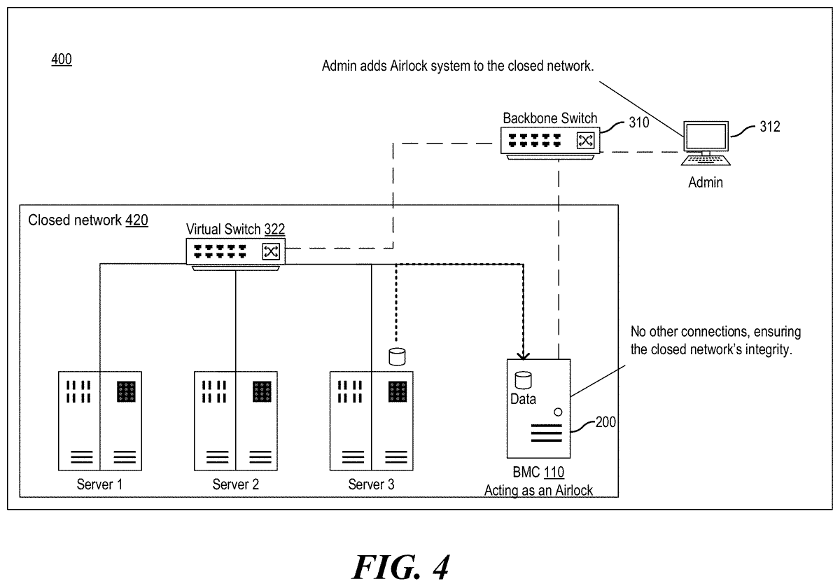

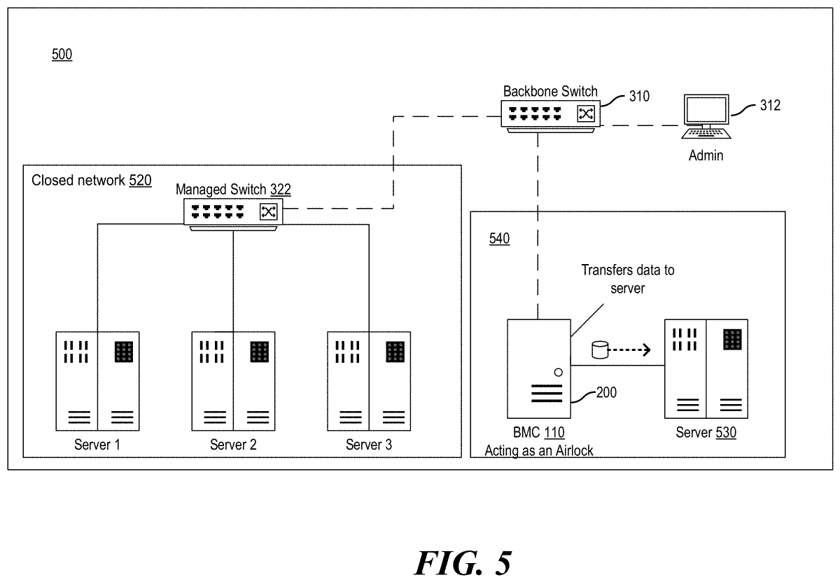

FIGS. 3-5 are diagrams of a network environment including a computing device that is able to convey data from a first closed network to another network environment, according to various examples. FIG. 3 includes a system 300 where a computing device 200 is preparing to convey data from a closed network 320 to another network environment. FIG. 4 includes a system 400 where the computing device 200 enters the closed network 420 and data is conveyed via the BMC 110 to a storage on the computing device 200. FIG. 5 includes a system 500 where the computing device 200 leaves the closed network 520 with the storage and enters a second network environment 540. The BMC 110 of the computing device can then transfer the data to a server 530.

FIG. 3 includes a system 300 where a computing device 200 is preparing to convey data from a closed network 320 to another network environment. The network interface 112 of the BMC 110 can be connected to a network switch 310. In some examples, the network switch can also be physically connected, but not virtually connected to the closed network 320. In other examples, the functionality described herein about changing networks for the BMC 110 can be performed on physical switches by moving Ethernet port connections on the switch. In one example, an administrator computing device 312 can be used to control a Virtual Private Network (VPN) or set of VPNs using one or more virtual switch 322.

In one example, the BMC 110 may be in a normal operating mode with a web server providing functionality. Then, an administrator connected to the BMC 110 via a network connection can cause the BMC 110 to enter into an air-lock courier mode. The BMC 110 can then perform a security assessment in response to entering the air-lock courier mode. The BMC 110, as part of the security assessment, can perform a check on the storage 114. The check on the storage 114 can include an erasure of the storage 114. In one example, secure erase instructions 216 can be executed by the BMC 110 to erase the content accessible on the storage 114. In one example, the secure erase can be compliant with a standard, for example, NIST 800-88R1 compliant. In some examples a manufacturer of the storage 114 can provide a secure erase command for the BMC 110 to utilize for parts of the storage. In other examples, the BMC 110 may perform a routine (e.g., encryption followed by erasure, writing one or multiple patterns, etc.) to ensure the secure erasure. In another example, the security assessment may include a check to ensure that the storage 114 is empty. In a further example, the security assessment may include a check that the storage 114 is clean of know malware.

In some examples, the security assessment includes executing the firmware scan instructions 218 by the BMC 110 to determine a firmware inventory of the computing device 210. In this example, the BMC 110 can take an inventory of multiple components that may be desirous to be protected and tracked. In some examples, the can wait until the next reboot of the computing device 100, 200 to perform the inventory. In other examples, the reboot is not needed.

Examples of devices or components to be inventoried include one or multiple processing elements or processors 130, memory 132, a system board and/or multiple components of the system board, bus devices on one or multiple bus (e.g., a PCIe bus), a controller hub and/or devices connected to the controller hub, field replaceable unit enclosures, a northbridge device, other ASICs, etc. As used herein, the system board is the main printed circuit board used for the computing device 100, 200 and allows communication between many of the components of the computing device, for example, the processor 130, the memory 132, peripherals, bus devices, etc. In some examples, a controller hub can be an I/O controller hub, for example a southbridge. The controller hub may be used to manage data communications between a CPU and other components of the system board. In some examples, a controller hub may have direct media interface to a northbridge device or the CPU. Further the controller hub may provide peripheral support for the computing device 200, such as bus connections like Universal Serial Bus (USB), Peripheral Component Interconnect (PCI), PCI express, PCI extended, serial AT attachment, audio circuitry, integrated Ethernet, enhanced host controller interfaces, combinations thereof, etc. Other examples of identifiers that can be used include system board revision identifiers, complex programmable logic device revision identifiers, ASIC stepping identifiers, platform and chassis identifiers, riser identifiers, embedded controller identifiers, battery and power identifiers, storage component identifiers, etc.

In one example, the BMC 110, can interrogate (e.g., send a query and receive a response) to and from each of the components to be inventoried. In another example, the BMC 110 can initiate another firmware component to facilitate in the interrogation. This may be performed by a particular sequence to ensure that each component is detected and inventoried. In some examples, an indirect approach can be used, for example, one or more bus on the computing device 100, 200 can be searched for components and then the components can be inventoried. As used herein, a bus is a communication system that transfers data between components inside the computing device 100, 200. Buses can include a PCIe bus, a memory bus, a universal serial bus, etc.

In some examples, a bus device can be included in a bus. As used herein, a peripheral device is a component that is not part of the essential computer (e.g., a main memory or central processing unit). An example of a peripheral device on a bus is a PCIe integrated network card or a PCIe graphics accelerator. In some examples, the BMC 110 is not directly connected to the component and another component (e.g., the controller hub) and/or one or more bus can act as an intermediary between the BMC 110 and the components. In some examples, the inventory can include one or more unique identifiers of the respective components. In other examples, the inventory can include other static information about the component.

As used herein a memory 132 is a component that can store information. The memory 132 can be volatile or non-volatile. Further, the memory 132 may be addressable by a central processing unit of the computing device 100, 200. An example of a memory includes a DIMM.

In some examples, the inventory can also include one or multiple configuration settings of firmware (e.g., platform firmware 220), other components of the system board, the BMC 110, field replaceable units (FRUs), etc. In some examples, the configuration information can include values for security settings, hardware enabled, hardware speed settings, voltage settings, etc. In other examples, the configuration information inventoried can include a subset of configuration settings that would normally not change between boots or with usage. In some examples, the inventory may also include at least one firmware version identifier for one or multiple firmware on the computing device 200. A firmware version identifier can be an identifier of a version of the firmware being implemented on a particular component. Moreover, in some examples, hardware training information and characteristics can be stored as part of the inventory.

The inventory taken at the time the mode is initiated can be stored in a stored inventory. In some examples, the stored inventory is a non-volatile memory. In some examples, the stored inventory is in a location that is only modifiable by the BMC 110 (e.g., a non-volatile location that cannot be modified outside of the BMC 110). In a further example, cryptographic information (e.g., a signature created using a cryptographic algorithm using the stored inventory) is also taken and stored in a secure location to ensure that the stored inventory is not modified. In one example, the secure location is in a Trusted Platform Module. In another example, the secure location is in a part of the BMC 110. In some examples, the secure location is a location that is only accessible via the BMC 110. As used herein, cryptographic information is information that can be used to determine whether the stored inventory at the time of initiation of the mode has been changed.

In some examples, the stored inventory is in the form of a hash. The hash can be implemented using a hash function, such as a cryptographic hash function (e.g., MD5, SHA, etc.) or other hash function. As used herein, hash can refer to each information of the components being separately hashed or for the whole inventory to be determined and then a single hash being taken for the whole inventory. In some examples, the stored inventory can be stored in plain text. Separate hashes allows for determining what changed to be simplified. In some examples, a key can be used in conjunction with the hash. As noted, in some examples, the stored inventory is in the form of a hash including a number of unique identifiers of the components found when the computing device 100, 200 was inventoried (e.g., when the computing device is put into the air-lock courier mode). In other examples, other information inventoried as described herein can be hashed as well.

In one example, when the computing device 100, 200 is placed in the air-lock courier mode, the inventory can be taken and stored as a golden inventory. This can occur when the BMC 110 is used to enable the air-lock courier mode. After transfer of data to another network, a new firmware scan can be performed to take another inventory that can be compared to the golden inventory.

The BMC 110 can also check that the BMC 110 is isolated from other potentially harmful networks prior to joining the closed network 320. The BMC 110 can check, for example, based on predetermined criteria that it is isolated. In one example, the BMC 110 can ping or otherwise contact one or multiple IP addresses (e.g., IP addresses on the internet, predetermined IP addresses, a known manufacturer Internet address or domain, a local Intranet address of a production side of a network, etc.) as part of the predetermined criteria. If contact occurs, the BMC 110 is not isolated and can send a message to the admin 312 or other log or message machine that it is not ready to connect to the closed network 320. In another example, if the BMC 110 determines that it is isolated from external networks meeting the criteria, the BMC 110 can send a ready message to the admin 312. In another example, the ready message can be sent further based on a determination that the security assessment has been passed (e.g., the firmware scan has been completed successfully, the BMC 110 is determined to be isolated from external networks meeting certain criteria, the storage 114 has been checked, etc.).

An admin device 312 can include access to a software defined networking controller and may be capable to configure the virtual switch 322. The admin device 312 can be used to change the setting such that the BMC 110 is connected, via the network interface 112, to the closed network 420 as shown in FIG. 4.

The BMC 110 can provide an API to allow a computing device (e.g., a management platform or another BMC executing a management subsystem on a server) such as server 3 to transfer data to the storage 114 on the computing device 200. In one example, the BMC 110 provides a limited API to allow for the transfer. As noted, the data can then be conveyed to the storage 114 using the BMC 110. In one example, an API can be exposed by the BMC 110 to specifically allow for the transfer. In one example, API can be implemented via the network interface 112. In another example, the API can be implemented via an interface between the BMC 110 and an operating environment of its associated computing device (e.g., via a channel interface (CHIF) driver capable of interfacing between a storage accessible to the BMC 110 and the CPU).

In some examples, the BMC 110 can execute instructions to scan the received data for storage to determine whether the received data is valid according to predetermined criteria. In one example, the information can be expected to be in a particular data structure type. Criteria that can be associated with that data structure type can be used as the predetermined criteria. For example, the criteria may expect particular characters to be included, rows and columns for a table, etc. associated with a particular format for the data structure type. In some examples, a BMC or management platform inside the closed network 320, 420 may be associated with one or multiple log type, message, etc. and that data structure type can be used to determine the criteria. Examples may include active health system logs, error logs, etc. The data transferred can be checked for conformance to expected data structure. The data can be considered valid if it conforms to an expected form.

If the data is not compliant with the expected form, it could mean that a malicious actor is attempting to transfer information that should be kept within the closed network 320, 420. Accordingly, the BMC 110 can perform a security action if the data is not valid. The security action can include notifying an administrator node (e.g., node 312 or another management platform).

In some examples, a management platform may be a software executing on hardware to manage servers via a management network. The management network can be separate from a production network that normal server traffic uses. The management platform can include a rack scale management software. Further, in some examples, the management platform may execute on a virtual machine of a server.

As shown in system 500, the BMC 110 can then be moved to a second network environment 540. In some examples, the BMC 110 is first isolated from the first network environment 420, 520 and is then connected to the second network environment 540. This change can occur, for example, by modifying, by the virtual switch 322 a logical network associated with a port on the backbone switch 310 assigned to the BMC 110. This network environment 540 can include a target computing device 530. The BMC 110 can be set up such that the target can retrieve the data from the BMC using an exposed API. In some examples, protections can be built into the API used. In one example, the target computing device 530 can be provided information to connect to the BMC 110 (e.g., a name of the BMC 110 on the network, an IP address, etc.) Further, the target computing device 530 may be able to authenticate with the BMC 110 to receive the data on the storage 114.

In one example, the BMC 110 provides an API with limited available functionality while in the air-lock mode. Accordingly, the target computing device 530 may use a particular API provided by the BMC 110 to retrieve the data from the storage. In another example, the BMC 110 can be configured to look for a particular target computing device 530 and transfer the data using a predetermined method once the target device is present (e.g., the BMC 110 can authenticate with the target device once on the second network environment and then push the data to the target device). In some examples, the server 530 can be capable to consume the data. For example, a software such as an insight remote support software, can execute to consume the data. In this example, consuming the data can mean to take the data and process the data for a purpose. In this case, the purpose may be, for example, to analyze the data. In one example, the data can be analyzed to determine a fault, a root cause error, a potential field replaceable unit to identify for replacement, etc. The consumption can be automated to utilize a format that meets the predetermined criteria.

The BMC 110 can then be removed from the second network environment 540 and return to an isolated state, for example, the network diagram from FIG. 3. This can occur using the virtual switch 322. As noted previously, though the description uses the virtual switch 322 example, a physical port unplug and placement into another switch port can be used.

At this point, the BMC 110 can perform a cleanup on the storage 114, for example, using a secure erase, performing other set up approaches prior to connecting to closed network 320, etc. Further, the BMC 110 can perform a secure erase on the storage to ensure that the data conveyed is removed and ensure that the storage cannot have potential malicious information stored thereon and/or ensure that potentially sensitive information in the data cannot be later retrieved.

In one example, the BMC 110 can take another firmware scan and compare with the previous firmware scan's inventory to ensure that the BMC and/or other firmware on the computing device 200 was not compromised by connecting to the second network environment 540. The same process described above can be performed to determine a firmware inventory and/or associated hash. In one example, the currently taken inventory and/or hash can be compared to a golden inventory and/or hash. In another example, the currently taken inventory or hash can be compared to the inventory and/or hash taken prior to the BMC 110 accessing the second network environment 540. The BMC 110 can reboot and perform a secure startup processes, for example using a hardware root of trust.

The startup of the BMC 110 can include a secure boot block that does not change by firmware updates and is associated with a hash that can be secured by a secure root of trust. During the secure boot process, the process can initialize a secure check of the BMC 110 firmware and/or settings, and then boot the firmware and/or settings.

If at any point in the process, the BMC 110 detects that an unauthorized modification has occurred (e.g., hashes and/or inventories not compared to be the same), the BMC 110 can perform a security action. The security action can include, for example, notifying a management platform of the unauthorized modification, indicating that it should not be attached to a new network, indicating a potential malicious activity, etc. If the BMC 110 does not detect an unauthorized modification, the BMC 110 can again be used as an air-locked courier. In one example, in response to a determination that an unauthorized modification did not occur, the BMC 110 can indicate a ready status to be capable to connect to the closed network 320. In some example, the BMC 110 stays in the courier mode and the BMC 110 can perform the erase noted above, the reboot process, and/or the determination of whether or not an unauthorized modification as part of the security assessment.

One or multiple engines can be used to implement various features described herein. Engines include hardware and/or combinations of hardware and programming to perform functions provided herein. Moreover, functionality attributed to a particular engine may also be implemented using another engine, instructions executing on a processing element, etc.

A processor 130, such as a central processing unit (CPU) or a microprocessor suitable for retrieval and execution of instructions and/or electronic circuits can be configured to perform the functionality various activity described herein. In certain scenarios, instructions and/or other information, such as production level application software, can be included in memory 132 or other memory. Input/output interfaces 234 may additionally be provided by the computing device 200. For example, input devices 240, such as a keyboard, a sensor, a touch interface, a mouse, a microphone, etc. can be utilized to receive input from an environment surrounding the computing device 200. Further, an output device 242, such as a display, can be utilized to present information to users. Examples of output devices include speakers, display devices, amplifiers, etc. Moreover, in certain examples, some components can be utilized to implement functionality of other components described herein. Input/output devices such as communication devices like network communication devices or wireless devices can also be considered devices capable of using the input/output interfaces 234.

A communication network can use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, a communication network can be in the form of a direct network link between devices rather than via a switch. Various communications structures and infrastructure can be utilized to implement the communication network(s).

Devices on a communication network communicate with each other and other components with access to the communication network via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information.

An Operating System is a system software that manages computer hardware and software resources and provides common services for computer programs. The OS can be executable on processing element and loaded to memory devices. The OS is a high level OS such as LINUX, WINDOWS, UNIX, a bare metal hypervisor, or other similar high level software that a boot firmware engine of the computing device 200 turns control of the computing device 200 to.

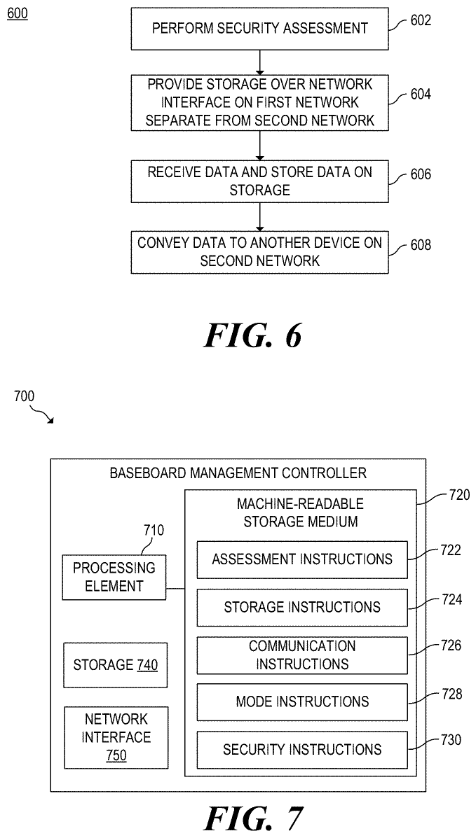

FIG. 6 is a flowchart of a method for using a baseboard management controller to convey data, according to an example. FIG. 7 is a block diagram of a baseboard management controller capable to convey data, according to an example. The BMC 700 includes, for example, a processing element 710, and a machine-readable storage medium 720 including instructions 722, 724, 726, 728, 730 for conveying data between a closed network and another network.

Processing element 710 may be, one or multiple processing unit, one or multiple semiconductor-based microprocessor, one or multiple graphics processing unit (GPU), other hardware devices suitable for retrieval and execution of instructions stored in machine-readable storage medium 720, or combinations thereof. The processing element 710 can be a physical device. Moreover, in one example, the processing element 710 may include multiple cores on a chip, include multiple cores across multiple chips, multiple cores across multiple devices (e.g., if the BMC 700 includes multiple node devices), or combinations thereof. Processing element 710 may fetch, decode, and execute instructions 722, 724, 726, 728, 730 to implement methods described herein. As an alternative or in addition to retrieving and executing instructions, processing element 710 may include at least one integrated circuit (IC), other control logic, other electronic circuits, or combinations thereof that include a number of electronic components for performing the functionality of instructions 722, 724, 726, 728, 730.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for conveying data in an air-lock mode.

In some examples, the network interface 750 can be implemented using an application specific integrated circuit (ASIC). An example of a network interface 750 can include an Ethernet interface. The Ethernet interface that may be coupled to an Ethernet port. In some examples, the storage 740 and network interface 750 are included on the BMC 700. In other examples, the storage 740 and network interface 750 can be coupled to the BMC 700.

Although execution of method 600 is described below with reference to BMC 700, other suitable components for execution of method 600 can be utilized (e.g., computing devices 100, 200). Additionally, the components for executing the method 600 may be spread among multiple devices. Method 600 may be implemented in the form of executable instructions stored on a machine-readable storage medium, such as storage medium 720, and/or in the form of electronic circuitry.

Method 600 can begin at 602, where the processing element 710 can execute assessment instructions 722 to perform a security assessment. The security assessment can include a check on a storage prior to connecting to a closed network. As described above, the security assessment can also include a firmware scan to take a firmware inventory of a computing device that is associated with the BMC 700. As noted above, in some examples, the firmware inventory can be stored for future use before connecting to a closed network. In some examples, the firmware inventory can be compared to a previous version prior to connecting to the closed network. In some examples, if the inventory does not match a message can be sent that the network interface should not be allowed on the closed network. Similarly, the network interface 750 can be taken offline in some examples.

Moreover, in some examples, the security assessment can include a self-assessment by the BMC 700 that the network interface 750 is isolated from external networks meeting a predetermined criteria. In some examples, the assessment can be in response to enabling an air-lock courier mode on the BMC 700 as described above. Enabling the air-lock courier mode can include receiving an instruction to use the mode and setting a setting to enable the mode. Mode instructions 728 can be used to implement the mode. As noted above, the mode can include implementing a limited API on the network interface 750. The network interface 750 can then be coupled to a closed network. As noted above, the closed network can be isolated from a second network where the data is to go.

At 604, the BMC can execute communication instructions to provide the storage 740, over the network interface 750 to the closed network that the BMC 700 is now a part of. Communication instructions 726 can cause an API to be provided that is limited. In one example, the limitation can include allowing for another device on the closed network to provide data to be stored on the storage 740 (e.g., via a put function), but not serving a full webserver that the BMC 700 may normally provide for out of band services.

At 606, the communication instructions 726 can be executed to receive the data. Further, the storage instructions 724 can be executed to cause the processing element 710 to store the data on the storage 740. In some examples, the data in the storage 740 can be sanitized. In one example, as part of the storing, the BMC 700 can scan the received data to determine whether the received data is valid according to predetermined criteria as described above.

In some examples, security instructions 730 can be executed by the processing element 710 based on the result of the scan. In particular, the BMC can perform a security action in response to a determination that the received data is not valid. For example, if the data is not in a form (e.g., a health log for a server) that is expected based on the predetermined criteria, a notification can be sent indicating that the information should not be transferred. In some examples, the BMC can quarantine the information and additional measures can be taken to keep it from being read. In other examples, the data can be deleted. In further examples, a message can be sent to an administrator. The BMC 700 can be set up to have expected places to transmit health or management information on one or more of the networks it connects to. The network interface 750 can then be connected to another network where a computing device is present to convey the data to.

At 608, communication instructions 726 can be executed to convey data to the computing device once on the second network. In some examples, the BMC 700 can be configured to push the data to the computing device. In other examples, the computing device can be used to communicate with the BMC and pull the data to the computing device. In some examples, as noted above, the computing device may include software that can consume the data.

After the BMC 700 has conveyed the data, the processing element 710 can run storage instructions 724 to delete the storage 740. The deletion can use a secure erase algorithm. Moreover, in some examples, after the network interface 750 has terminated connection with the second network, the BMC 700 can perform a second firmware scan to take another firmware inventory. The assessment instructions 722 can be executed to compare the previous firmware inventory with the current firmware inventory. The comparison can be used to determine whether an unauthorized modification occurred while connected to the second network. In one example, in response to determining that an unauthorized modification did not occur, a ready status can be set noting that the BMC 700 is ready to be connected to a closed network for a further transfer. In some examples, the BMC can return to block 602 after the transfer.

One or multiple electronic devices, switches, etc. can be implemented using one or multiple sets of processors and associated executable instructions stored on a computer readable medium and/or hardware logic.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A computing device comprising:
at least one processor;
memory;
a network interface;
a baseboard management controller (BMC) separate from the at least one processor,
wherein the network interface is coupled to the BMC and is configured to be set up in a first network that is isolated from a second network,
wherein the BMC is to:
provide a storage to convey data;
perform a security assessment including a check the storage prior to connecting to the first network;
receive the data and store the data on the storage while connected to the first network,
wherein after the network interface is disconnected from the first network and connected to the second network:
convey the data to another device using the second network.

2. The computing device of claim 1, wherein the BMC is to enable an air-lock courier mode, wherein, during the air-lock courier mode, the BMC is to determine that the BMC is isolated from external networks meeting predetermined criteria, as part of the security assessment.

3. The computing device of claim 2, wherein the BMC is further to, during the air-lock courier mode, execute a firmware scan to take an inventory of the computing device prior to connection to the first network.

4. The computing device of claim 3, wherein the BMC is further to:
scan the received data to determine whether the received data is valid according to predetermined criteria; and
perform a security action in response to a determination that the received data is not valid.

5. The computing device of claim 4, wherein the other device is capable to consume the data according to the predetermined criteria.

6. The computing device of claim 3, wherein the BMC is further to:
return to an isolated state after conveyance of the data using the second network; and
perform a secure erase on the storage.

7. The computing device of claim 6, wherein the BMC is further to:
perform a second firmware scan to take a second firmware state of the computing device;
compare the firmware state to the second firmware state; and
determine whether an unauthorized modification occurred.

8. The computing device of claim 7, wherein the BMC is further to:
in response to a determination that the unauthorized modification did not occur indicate a ready status to be capable to connect to the first network.

9. A method comprising:
performing, by a baseboard management controller (BMC) of a computing device, a security assessment including a check on a storage prior to connecting to a first network;
wherein the computing device includes at least one processor, a memory, a network interface, wherein the BMC is separate from the at least one processor,
wherein a network interface is coupled to the BMC and is configured to be set up in a first network that is isolated from a second network,
providing, by the BMC, a storage over the network interface to convey data,
receiving, by the BMC, the data;
storing, by the BMC, the data on the storage while connected to the first network,
wherein after the network interface is disconnected from the first network and connected to the second network:
conveying the data to another device using the second network.

10. The method of claim 9, further comprising:
enabling, by the BMC, an air-lock courier mode, wherein during the air-lock courier mode:
performing, by the BMC, a self-assessment to determine that the BMC is isolated from external networks meeting predetermined criteria, as part of the security assessment prior to connecting to the first network.

11. The method of claim 10, further comprising: during the air-lock courier mode, executing, by the BMC, a firmware scan to take a firmware inventory of the computing device prior to connection to the first network.

12. The method of claim 11, further comprising:
scanning, by the BMC, the received data to determine whether the received data is valid according to predetermined criteria; and
performing, by the BMC, a security action in response to a determination that the received data is not valid.

13. The method of claim 12, wherein the other device is capable to consume the data according to the predetermined criteria.

14. The method of claim 11, further comprising:
returning the BMC to an isolated state after conveyance of the data using the second network; and
performing, by the BMC, a secure erase on the storage.

15. The method of claim 14, further comprising:
performing, by the BMC, a second firmware scan to take a second firmware inventory of the computing device;
comparing, by the BMC, the firmware state to the second firmware inventory; and
determining, by the BMC, whether an unauthorized modification occurred.

16. The method of claim 15, further comprising:
in response to a determination that the unauthorized modification did not occur indicating, by the BMC, a ready status to be capable to connect to the first network.

17. A non-transitory machine-readable storage medium storing instructions that, if executed by a physical processing element of a baseboard management controller (BMC) of a computing device, cause the BMC to:
perform a security assessment including a check on a storage prior to connecting to a first network;
wherein the computing device includes at least one processor, a memory, a network interface, wherein the BMC is separate from the at least one processor,
wherein the network interface is coupled to the BMC and is configured to be set up in the first network that is isolated from a second network,
provide, a storage over a network interface to convey data,
receive, the data while connected to the first network;
store the data on the storage while connected to the first network; and
convey the data to another device using the second network after the network interface is disconnected from the first network and connected to the second network.

18. The non-transitory machine-readable storage medium of claim 17, further comprising instructions that, if executed by the physical processing element, cause the BMC to:
enable, an air-lock courier mode, wherein during the air-lock courier mode, the BMC is to:
perform a self-assessment to determine that the BMC is isolated from networks meeting a predetermined criteria, as part of the security assessment prior to connecting to the first network; and
execute a firmware scan to take a firmware inventory of the computing device prior to connection to the first network.

19. The non-transitory machine-readable storage medium of claim 18, further comprising instructions that, if executed by the physical processing element, cause the BMC to:
return the BMC to an isolated state after conveyance of the data using the second network;
perform a secure erase on the storage;
perform a second firmware scan to take a second firmware state of the computing device;
compare the firmware state to the second firmware inventory;
determine whether an unauthorized modification occurred; and
in response to a determination that the unauthorized modification did not occur indicate a ready status to be capable to connect to the first network.

20. The non-transitory machine-readable storage medium of claim 18, further comprising instructions that, if executed by the physical processing element, cause the BMC to:
scan the received data to determine whether the received data is valid according to predetermined criteria; and
perform, a security action in response to a determination that the received data is not valid.
